(19) United States
(12) Patent Application Publication
(10) Pub. No.: US 2026/0038872 A1
(43) Pub. Date: Feb. 5, 2026

(54) MIXED ION AND ELECTRON CONDUCTING LITHIUM GARNET FOR ALL-SOLID-STATE BATTERIES

(71) Applicant: University of Maryland, College Park, College Park, MD (US)

(72) Inventors: Eric D. Wachsman, Fulton, MD (US); George V. Alexander, College Park, MD (US)

(21) Appl. No.: 18/995,218

(22) PCT Filed: Jul. 17, 2023
(86) PCT No.: PCT/US2023/070322

§ 371 Date: Jan. 16, 2025

Related U.S. Application Data
(60) Provisional application No. 63/368,708, filed on Jul. 18, 2022.
(60) Provisional application No. 63/368,823, filed on Jul. 19, 2022.

(51) Int. Cl. H01M 10/0562; C01G 25/00; C01G 33/00; C01G 37/14; H01M 10/0525

(52) U.S. Cl. CPC H01M 10/0562; C01G 25/006; C01G 33/006; C01G 37/14; H01M 10/0525; C01P 2002/54; C01P 2002/72; C01P 2002/76; C01P 2004/03; C01P 2006/40; H01M 2300/0071; H01M 2300/0094

(57) ABSTRACT

In one aspect, the present invention provides a solid-state electrolyte material. The solid-state electrolyte material comprises a composition of Formula (XX), (XX-A), (XX-B), (XX-C), (I), (Ia), and/or (Ib), as described herein. Another aspect provides a method of making a green body. A further aspect provides a method of making a sintered solid-state electrolyte material.

### CROSS-REFERENCE TO RELATED APPLICATIONS

This application claims the benefit of U.S. Provisional Application No. 63/368,708, filed on Jul. 18, 2022, and U.S. Provisional Application No. 63/368,823, filed on Jul. 19, 2022. Each of these documents is hereby incorporated by reference in its entirety.

### GOVERNMENT LICENSE RIGHTS

This invention was made with government support under contract no. W911NF2220021 awarded by the Department of the Army, Army Research Office (ARO). The U.S. government has certain rights in the invention.

### FIELD OF THE INVENTION

The present disclosure relates to mixed ion and electron conducting solid-state electrolyte materials suitable for use in solid-state lithium batteries.

### BACKGROUND

Lithium-ion batteries are suitable as power sources in a wide range of applications due to the high energy densities, high coulombic efficiencies, and low self-discharge features that such batteries provide. However, conventional lithium-ion batteries present certain disadvantages. Conventional lithium-ion batteries typically comprise a graphite-based anode, an insertion-type cathode, and a liquid electrolyte. The liquid electrolyte used in conventional lithium-ion batteries is flammable, and is susceptible to leakage and decomposition under certain conditions.

Solid-state electrolytes are considered a promising, non-flammable, alternative to conventional liquid electrolytes. Solid-state electrolytes have a rigid structure. Additionally, solid-state electrolytes allow for the use of lithium metal as an anode active material, thereby increasing the gravimetric and volumetric energy densities of batteries incorporating such solid-state electrolytes.

Over the past few decades, development of fast, solid lithium-ion conductors for potential application as solid-state electrolytes in all-solid-state lithium batteries has been a focus of research. Prog. Mater. Sci. 88 (2017): 325-411. Solid lithium-ion conductors have been reported across a wide range of crystalline metal oxides and sulfides. Generally, metal oxides have shown the greatest promise because of the ease of preparation, desirable mechanical properties, and desirable thermal stability associated with these solid lithium-ion conductors. Most metal oxide lithium-ion conductors exhibit either high lithium ion (Li⁺) conductivity or high electrochemical stability toward lithium. The first report of fast lithium-ion conduction in garnet-type lithium containing transition metal oxides, having a nominal chemical composition of Li₅La₃B₂O₁₂, wherein B is Nb or Ta, stimulated extensive research on the synthesis, structure, and lithium ion conducting properties of numerous lithium stuffed gamets. J. Am. Ceram Soc. 86 (2003) 437. Cubic phase Li₇La₃Zr₂O₁₂ (LLZO), exhibiting a lithium-ion conductivity of 10⁻⁴ S/cm, represented a breakthrough in the field. Angew. Chem Int. Ed. 41 (2007) 7778-7781.

Despite the promises of high lithium-ion conductivity and stability towards metallic lithium, all-solid-state lithium-ion batteries based on cubic gamet structured solid electrolytes still present challenges due to their high electrode-electrolyte interfacial resistances. Various strategies have been implemented to overcome these high interfacial resistances. Nano Lett. 17 (2017) 565-571: 1 Mater. Chem. A 6 (2018) 11463-11470; Adv. Energy Mater. 8 (2018) 1701963; Adv. Mater. 31 (2019) 1804815; and Electrochim. Acta 332 (2020) 135511. Among these strategies, introduction of a metal oxide buffer layer over the garnet solid-state electrolyte reinforces lithium-garnet contact and modulates lithium ion transfer at the interface. However, based on the volumetric capacity of lithium metal, stripping 1 mAh cm⁻² of lithium may create an interfacial gap of approximately 5 μm during cell cycling, and the buffer layer may not remain the same after continuous lithium stripping/plating cycles. Adv. Mater. 31 (2019) 1804815. As such, both increased stripping/plating cycles and also high-capacity lithium stripping are difficult to achieve through interface modification techniques.

A potential alternative to modification of the electrode-electrolyte interface is to develop a solid-state electrolyte material that is porous and exhibits both high lithium ion conductivity and high electron conductivity (e.g., mixed ion and electron conducting (MIEC) solid-state electrolyte materials). The lithium ion conductivity of these potential solid-state electrolyte materials ensures ionic channels at the interface. Moreover, the electron conductivity may alleviate lithium ion concentration gradients, leveling the local current distribution at the lithium/gamet interface (i.e., electrode-electrolyte interface) and facilitating high critical current density. MIEC solid-state electrolyte materials may also allow for “Li-free” anodes when incorporated as the porous layer of bilayer and trilayer structures described in U.S. Pat. No. 10,622,666, the contents of which is hereby incorporated by reference in its entirety. Accordingly, MIEC solid-state electrolyte materials may reduce material costs associated with solid-state battery production, simplify processing, and increase cell energy density of any resultant solid-state battery. Specifically, MIEC solid-state electrolyte materials may achieve these particular benefits by circumventing the need to process expensive lithium metal, since it may be possible for lithium to be supplied from a lithiated cathode.

MIEC solid-state electrolyte materials may also be useful in composite cathodes of an all-solid-state battery. Conventional cathodes in all-solid-state batteries are typically prepared via a co-sintering technique or thin film coating techniques. For the co-sintering technique, a cathode active material is mixed with the solid electrolyte and electron conducting additives, such as carbon, to form an inter-connected pathway for lithium ions and electrons. These methods are often limited by the stability of the constituent materials. One potential solution is to prepare a composite solid-state cathode comprising a cathode active material and a MIEC solid-state electrolyte material.

To date, MIEC solid-state electrolyte materials in the context of solid-state batteries have not been extensively explored. In a solid-state battery with a lithium garnet as the solid-state electrolyte material, implementation of a single-phase MIEC lithium garnet may reduce the need for additional electron conducting additives, thereby potentially increasing gravimetric energy density of the solid-state battery. Previously, efforts were made to improve the electron conductivity of a lithium garnet by doping multivalent transition metals at the Zr-site. Ceram Int. 3 (2020) 3731-3737, J. Electrochem. Soc. 10 (2018) A2303. However, this doping alone was insufficient to introduce electronic conductivity in a lithium gamet, due to the separation of ZrO₆ octahedra (˜6.5 Å). J. Am. Ceram. Soc. 2 (2005) 411 418. Such lithium garnets exhibited electronic conductivity in the range of from about 10⁻⁶ S/cm to about 10⁻⁸ S/cm, and included significant secondary phases potentially susceptible to undesirable reactions reaction with other constituents in the solid-state battery.

As such, there remains a need to provide improved MIEC solid-state electrolyte materials.

### SUMMARY OF THE INVENTION

In one aspect, the present invention provides a solid-state electrolyte material comprising a composition of Formula (XX):

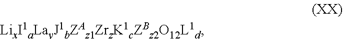

wherein,
I¹ is H, Be, B, Al, Fe, Zn, Ga, or any combination thereof;
J¹ is Na, K, Ca, Rb, Sr, Y, Ag, Ba, Bi, Nd, Pm, Gd, Tb, Ho, Er, or Tm, or any combination thereof;
K¹ is Mg, Si, Sc, Ti, V, Ni, As, Se, Tc, Cd, In, Sn, Hf, Ta, Au, Hg, Pb, Ce, Eu, or any combination thereof;
L¹ is F, Cl, Br, I, S, Se, Te, N, P. or any combination thereof;
Z^{A} is Ce, Dy, Eu, Pb, Pr, Sm, Yb, or any combination thereof;
Z^{B} is Co, Cr, Cu, Fe, Ge, Ir, Mn, Mo, Nb, Os, Pd, Pt, Re, Rh, Ru, Sb, Ta, Tb, Ti, V, W. or any combination thereof;
Each of a, b, c, and d is independently 0≤a, b, c, d≤1;
0<x≤7;
0≤y<3.5;
0≤z<2.5;
0<z1≤3.5;
0<z2≤3.5,
   provided that
x+a=7;
y+b+z1≤3.5; and
z+z2+c≤3.5.

In one aspect, the present invention provides a solid-state electrolyte material comprising a composition of Formula (I):

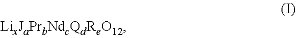

wherein,
J is H, Be, B, Al, Fe, Zn, Ga, or any combination thereof;
Q is Zr, W, or any combination thereof;
R is Sc, Ti, V, Cr, Mn, Fe, Co, Ni, Cu, Zn, Y, Zr, Nb, Mo, Tc, Ru, Rh, Pd, Ag, Cd, Lu, Hf, Ta, Re, Os, Ir, Pt, Au, Hg, Lr, Rf, Db, Sg, Bh, Hs, Mt, Ds, Rg, Cn, Ce, Ge, Sb, Tb, or any combination thereof;
0<x≤7;
0≤a≤1;
0<b≤3.5;
0≤c≤1;
0<d≤2.5; and
0≤e≤1.

In some embodiments, J is Ga. In other embodiments, Q is Zr. And, in some embodiments, Q is W.

In some embodiments, R is Nb, Ce, Cr, or any combination thereof. For example, R is Nb. In other embodiments, R is Ce. And, in some embodiments, R is Cr.

In some embodiments, 2.5<x≤7. In other embodiments, 5<x≤7. In some embodiments, 6<x≤7. And, in some embodiments, 1.5<x<4.5.

In some embodiments, 0≤a≤0.7. In other embodiments, 0<a<0.7. In some embodiments, 0<a<0.5. And, in some embodiments, a is 0.

In some embodiments, 1<b<3.5. In other embodiments, 2<b<3.5. And, in some embodiments, 2.5≤b<3.5.

In some embodiments, 0≤c<1. In other embodiments, 0≤c<0.8. In some embodiments, 0.3<c<0.7. And, in some embodiments, c is 0.

In some embodiments, 1<d<2.5. In other embodiments, 1.5<d<2.5. And, in some embodiments, 1.5<d≤2.0.

In some embodiments, 0<e≤0.75. In other embodiments, 0<e≤0.5. In some embodiments, 0<e≤0.3. And, in some embodiments, e is 0.

In another aspect, the present invention provides a solid-state electrolyte material comprising a composition of a formula selected from
Li_{6.2} Ga_{0.2}Pr₃Zr_{1.8}Nb_{0.2}O₁₂;
Li_{6.4}Ga_{0.2}Pr₃Zr_{1.8}Ce_{0.2}O₁₂;
Li_{6.4} Ga_{0.2}Pr_{2.5}Nd_{0.5}Zr₂O₁₂;
Li_{6.6}Ga_{0.2}Pr₃Zr_{1.8}Cr_{0.2}O₁₂; or
Li₃Pr_{2.5}Nd_{0.5}W₂O₁₂.

In a further aspect, the present invention provides a solid-state electrolyte material comprising a composition of Formula (Ia):

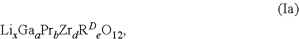

wherein R^{D}, x, a, b, d, and e are as defined herein.

In some embodiments, R^{D} is W, Sc, Ti, V, Cr, Mn, Fe, Co, Ni, Cu, Zn, Y, Zr, Nb, Mo, Tc, Ru, Rh, Pd, Ag, Cd, Lu, Hf, Ta, Re, Os, Ir, Pt, Au, Hg, Lr, Rf, Db, Sg, Bh, Hs, Mt, Ds, Rg, Cn, Ce, Ge, Sb, Tb, or any combination thereof. In some embodiments, R^{D} is Nb, Ce, Cr, or any combination thereof. For example, R^{D} is Nb. In other embodiments, R^{D} is Ce. In some embodiments, R^{D} is W. And, in some embodiments, R^{D} is Cr.

In some embodiments,

$$0 < x \leq 7 ;$$

$$0 \leq a \leq 1 ;$$

$$0 < b \leq 3.5 ;$$

$$0 < d \leq 2.5 ; and$$

$$0 \leq e \leq 1 .$$

In some embodiments,

$$6 < x < 7 ;$$

$$0 < a < 1 ;$$

$$2. < b < 3.5 ;$$

$$1 < d < 2 ; and$$

$$0 < e < 0.5 .$$

In some embodiments, 6.2≤x≤6.8. In other embodiments, 0<a<0.3. In some embodiments, 2.25<b<3.25. In some embodiments, 1.5<d<2.25. And, in some embodiments, 0<e<0.3.

In another aspect, the present invention provides a solid-state electrolyte material comprising a composition of Formula (Ib):

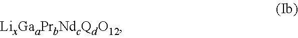

wherein Q, x, a, b, c, and d are as defined in the composition of Formula (I), or any embodiment thereof.

In some embodiments, Q is Zr, W, or any combination thereof. In some embodiments, Q is W. In other embodiments, Q is Zr.

In some embodiments,

$$0 < x \leq 7 ;$$

$$0 \leq a \leq 1 ;$$

$$0 < b \leq 3.5 ;$$

$$0 \leq c \leq 1 ; and$$

$$0 < d \leq 2.5 .$$

In some embodiments,

$$2.5 < x < 7 ;$$

$$0 \leq a < 0.5 ;$$

$$2 < b < 3 ;$$

$$0 < c < 1 ; and$$

$$0 < d \leq 2 .$$

In some embodiments,
Q is W; and
a is 0.

In some embodiments, 2.5<x<3.5.

In some embodiments,
Q is Zr; and
0<a<0.5.

In some embodiments, a solid-state electrolyte material comprising a composition of Formula (I), (Ia), and/or (Ib) is ion conducting and electron conducting. In some embodiments, the solid-state electrolyte material has a lithium ion conductivity of at least about 0.05 mS/cm. In other embodiments, the solid-state electrolyte material has a lithium ion conductivity of at least about 0.09 mS/cm. And, in some embodiments, the solid-state electrolyte material has a lithium ion conductivity of at least about 0.11 mS/cm.

In some embodiments, the solid-state electrolyte material has an electron conductivity of at least about 1 μS/cm. In other embodiments, the solid-state electrolyte material has an electron conductivity of at least about 2.5 μS/cm. And, in some embodiments, the solid-state electrolyte material has an electron conductivity of at least about 10 μS/cm.

In some embodiments, the solid-state electrolyte material has an ambipolar conductivity of at least about 1 μS/cm. In other embodiments, the solid-state electrolyte material has an ambipolar conductivity of at least about 2.5 μS/cm. And, in some embodiments, the solid-state electrolyte material has an ambipolar conductivity of at least about 7.5 μS/cm.

In some embodiments, a solid-state electrolyte material comprising a composition of Formula (XX), (XX-A), (XX-B), (XX-C), (I), (Ia), and/or (Ib) has a cubic phase. In other embodiments, the solid-state electrolyte material is substantially free of a secondary phase.

Another aspect of the present invention provides an electrode for a solid-state battery comprising a solid-state electrolyte material comprising a composition of Formula (XX), (XX-A), (XX-B), (XX-C), (I), (Ia), and/or (Ib).

Another aspect of the present invention provides a bilayer solid-state electrolyte structure comprising a porous layer and a dense layer. At least one of the porous layer and the dense layer comprises a solid-state electrolyte material comprising a composition of Formula (XX), (XX-A), (XX-B), (XX-C), (I), (Ia), and/or (Ib). In some embodiments, the porous layer comprises the solid-state electrolyte material.

Another aspect of the present invention provides a trilayer solid-state electrolyte structure, comprising a first porous layer, a dense layer, and a second porous layer. At least one of the first porous layer, the dense layer, and the second porous layer comprises a solid-state electrolyte material comprising a composition of Formula (XX), (XX-A), (XX-B), (XX-C), (I), (Ia), and/or (Ib). In some embodiments, at least one of the first porous layer and the second porous layer comprises the solid-state electrolyte material. In other embodiments, the first porous layer and the second porous layer each independently comprise the solid-state electrolyte material.

Another aspect of the present invention provides a solid-state battery comprising a solid-state electrolyte material as described herein, an electrode as described herein, a bilayer solid-state electrolyte structure as described herein, or a trilayer solid-state electrolyte structure described as herein.

In some embodiments, the solid-state electrolyte material is sintered. In some embodiments, the sintered electrolyte material is incorporated into a ceramic separator. In some embodiments, the sintered electrolyte material is incorporated into a host structure for lithium metal plating and stripping. In some embodiments, the sintered electrolyte material is in physical contact with a cathode material and anode material, forming a combined electrode pair and separator layer.

In another aspect, the present invention provides a method of forming a green body comprising a solid-state electrolyte material described herein.

In another aspect, the present invention provides a method of forming a sintered solid-state electrolyte material as described herein.

### BRIEF DESCRIPTION OF THE DRAWINGS

The figures below are provided by way of example and are not intended to limit the scope of the claimed invention.

FIG. 1 is X-ray diffraction patterns for exemplary embodiments of mixed ion and electron conducting (MIEC) solid-state electrolyte materials according to Example 1 and a Li₇La₃Zr₂O₁₂ (LLZO) cubic garnet structure. Starred peaks indicate PrO₂ peaks. An image of an exemplary embodiment of a MIEC solid-state electrolyte material is inset.

FIG. 2 is a Nyquist plot of a tantalum doped LLZO (Ta-doped LLZO) solid-state electrolyte material and various exemplary embodiments of MIEC solid-state electrolyte materials measured at room temperature (i.e., 22° C.).

FIG. 3 is chronoamperometry measurements for a Ta-doped LLZO solid-state electrolyte material and various exemplary embodiments of MIEC solid-state electrolyte materials measured at room temperature (i.e., 22° C.).

FIG. 4 is a graph of lithium ion conductivity and electronic conductivity of a Ta-doped LLZO solid-state electrolyte material and various exemplary embodiments of MIEC solid-state electrolyte materials.

FIG. 5A is a cross-sectional scanning electron microscope (SEM) image of an exemplary embodiment of a trilayer comprising a MIEC solid-state electrolyte material.

FIG. 5B is a critical current density measurement of an exemplary embodiment of a symmetrical cell comprising a MIEC solid-state electrolyte material.

FIG. 5C is a graph of galvanostatic stripping/plating of an exemplary embodiment of a symmetrical cell comprising a MIEC solid-state electrolyte material at different current densities measured at room temperature (i.e., 22° C.) with no applied pressure.

FIG. 6A is an initial charge-discharge profile of an exemplary embodiment of a battery cell comprising a MIEC solid-state electrolyte material.

FIG. 6B is a graph of discharge capacity and coulombic efficiency of an exemplary embodiment of a battery cell comprising a MIEC solid-state electrolyte material, wherein the battery cell is cycled at 0.1 C for 100 cycles.

### DETAILED DESCRIPTION

The present invention provides a mixed ion and electron conducting (MIEC) solid-state electrolyte material, a battery cell comprising such a MIEC solid-state electrolyte material, and methods of forming such a MIEC solid-state electrolyte material.

As used herein, the following definitions shall apply unless otherwise indicated.

### I. Definitions

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having.” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

As used herein, when an element is referred to as being “on,” “engaged to,” “connected to,” “attached to.” or “coupled to” another element, it may be directly on, engaged, connected, attached, or coupled to the other element, or intervening elements may be present. In contrast, when an element is referred to as being “directly on,” “directly engaged to,” “directly connected to,” “directly attached to,” or “directly coupled to” another element, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

As used herein, the term “doping” and other forms of the word refer to the presence or placement of atoms other than the base atoms in the crystal structure of the garnet material. For example, for the base structure of Li₇La₃Zr₂O₁₂ (LLZO), an atom can be substituted for a portion or all of the lithium, a portion or all of the lanthanum, a portion or all of the zirconium and/or a portion or all of the oxygen. Such substitution can be made after forming the base structure or during the formation of the base structure. Similar substitutions can be made for other garnet-based structures.

As used herein, the term “gamet” refers to the cubic or tetragonal crystal structure of LLZO.

As used herein, the term “solid-state electrolyte material” refers to a material that is suitable for use in a solid-state battery cell. The solid-state electrolyte material comprises a composition of Formula (XX), (XX-A), (XX-B), (XX-C), (I), (Ia), and/or (Ib).

As used herein, the term “green body” refers to an unsintered body (e.g., a tape and/or film) that comprises a solid-state electrolyte material.

As used herein, the term “porosity” refers to a volume ratio of space not occupied by the subject material (e.g., a solid-state electrolyte material) to the overall volume of the subject material, except where the context indicates otherwise. In some embodiments, unoccupied space at an edge of the subject material (e.g., a depression in an exterior surface of the subject material) is not included in the porosity determination.

As used herein, the term “secondary phases”, except where context indicates otherwise, refers to non-desired compositions that form in the structure. The secondary phases can be non-garnet or garnet. For secondary phase garnets, the composition might be different from that desired or it might have dopants located at incorrect sites. Frequently, secondary phases can impair structural or performance characteristics of the solid-state electrolyte material. For example, secondary phases may give rise to increased impedance or weakened structural properties of the solid-state electrolyte material. Exemplary secondary phases include, but are not limited to, Li₂O, Li₂CO₃, Al₂O₃, LiAlO₂, La₂Zr₂O₇, LaTaO₄, CaO, CaCO₃, ZrO₂, Li₂ZrO₃, Li₃BO₃, Li—Ca—B—O, etc. More than one secondary phase may be present.

As used herein, the term “substantially free of a secondary phase” refers to a solid-state electrolyte material comprising less than about 20%, less than about 15%, less than about 10%, less than about 5%, less than about 4%, less than about 3%, less than about 2%, or less than about 1% of a secondary phase. In some embodiments, the solid-state electrolyte material is free of a secondary phase.

As used herein, the term “ambipolar conductivity” refers to a conductivity of a solid-state electrolyte material calculated according to formula (1):

$${σ}_{a} = {σ}_{i} {σ}_{e} / ( {σ}_{i} + {σ}_{e} ) , \qquad ( 1 )$$

wherein
σₐ is ambipolar conductivity;
σᵢ is lithium ion conductivity; and
σₑ is electron conductivity.

### II. Solid-State Electrolyte Material

In one aspect, the present invention provides a solid-state electrolyte.

Some embodiments of the present invention provide a solid-state electrolyte material comprising a composition of Formula (XX):

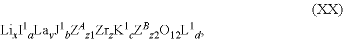

wherein,
I¹ is H, Be, B, Al, Fe, Zn, Ga, or any combination thereof;
J¹ is Na, K, Ca, Rb, Sr, Y, Ag, Ba, Bi, Nd, Pm, Gd, Tb, Ho, Er, or Tm, or any combination thereof;
K¹ is Mg, Si, Sc, Ti, V, Ni, As, Se, Tc, Cd, In, Sn, Hf, Ta, Au, Hg, Pb, Ce, Eu, or any combination thereof;
L¹ is F, Cl, Br, I, S, Se, Te, N, P. or any combination thereof;
Z^{A} is Ce, Dy, Eu, Pb, Pr, Sm, Yb, or any combination thereof;
Z^{B} is Co, Cr, Cu, Fe, Ge, Ir, Mn, Mo, Nb, Os, Pd, Pt, Re, Rh, Ru, Sb, Ta, Tb, Ti, V, W, or any combination thereof;
Each of a, b, c, and d is independently 0≤a, b, c, d≤1;

$$0 < x \leq 7 ;$$

$$0 \leq y < 3.5 ;$$

$$0 \leq z < 2.5 ;$$

$$0 < z 1 \leq 3.5 ;$$

$$0 < z 2 \leq 3.5 ,$$

provided that

$$x + a = 7 ;$$

$$y + b + z 1 \leq 3.5 ; and$$

$$z + z 2 + c \leq 3.5 .$$

In some embodiments:
(a) I¹ is H, Be, B, Al, Fe, Zn, or Ga;
(b) J¹ is Na, K, Ca, Rb, Sr, Y, Ag, Ba, Bi, Nd, Pm, Gd, Tb, Ho, Er, or Tm;
(c) K¹ is Mg, Si, Sc, Ti, V, Ni, As, Se, Tc, Cd, In, Sn, Hf, Ta, Au, Hg, Pb, Ce, or Eu;
(d) L¹ is F, Cl, Br, I, S, Se, Te, N, or P;
(e) Z^{A} is Ce, Dy, Eu, Pb, Pr, Sm, or Yb;
(f) Z^{B} is Co, Cr, Cu, Fe, Ge, Jr, Mn, Mo, Nb, Os, Pd, Pt, Re, Rh, Ru, Sb, Ta, Tb, Ti, V, or W;
(g) each of a, b, c, and d is independently 0≤a, b, c, d≤1;

$$( g ) 0 < x \leq 7 ;$$

$$( h ) 0 \leq y < 3 ;$$

$$( i ) 0 \leq z < 2 ;$$

$$( j ) 0 < z 1 \leq 3 ;$$

$$( k ) 0 < z 2 \leq 2 ,$$

provided that

$$x + a = 7 ;$$

$$y + b + z 1 \leq 3 ; and$$

$$z + z 2 + c \leq 2 .$$

In some embodiments, x is 6<x≤6.75 and a is 0.25≤a≤1, and I¹ is selected from H, B, Al, Fe, or Zn.

In some embodiments, y is 1.75<y<2.25, b is 0.25<y<0.75, z1 is 0.25<y<0.75, and b+z1≤1, where J¹ is Na, K, Ca, Rb, Sr, Y, Ba, Bi. or Nd, and Z^{A} is Ce, Pb, Pr, Sm, or Yb.

In some embodiments, z is 0.5<z<1, c is 0.5<y<1, z2 is 0.5<z2<1, and c+z2≤1.25, where K¹ is Mg, Si, Ti, V, Ni, As, Cd, In, Sn, Ta, Pb, or Ce, and Z^{B} is Co, Cr, Cu, Ge, Mn, Mo, Nb, Os, Pd, Pt, Re, Rh, Ru, Sb, Ta, Tb, Ti, V, or W.

In some embodiments, d is 0≤d≤0.25, and L¹ is F, Cl, Br, I, or N.

Some embodiments of the present invention provide a solid-state electrolyte material comprising a composition of Formula (XX-A):

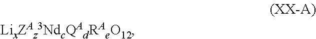

wherein
Z^{A} is Ce, Dy, Eu, Pb, Pr, Sm, Yb, or any combination thereof;
Q^{A} is Zr, W, or any combination thereof;
R^{A} is Sc, Ti, V, Cr, Mn, Fe, Co, Ni, Cu, Zn, Y, Zr, Nb, Mo, Tc, Ru, Rh, Pd, Ag, Cd, Lu, Hf, Ta, Re, Os, Ir, Pt, Au, Hg, Lr, Rf, Db, Sg, Bh, Hs, Mt, Ds, Rg, Cn, Ce, Ge, Sb, Tb, or any combination thereof:

$$0 < x \leq 7 ;$$

$$0 < {z}^{3} \leq 4.5 ;$$

$$0 \leq c \leq 1 ;$$

$$0 < d \leq 2.5 ;$$

$$0 \leq e \leq 1 .$$

In some embodiments, Z is Ce, Dy, Eu, Pb, Sm, Yb, or any combination thereof, and z³ is 0<z³≤4.5 (e.g., z³ is 0<z³≤4.0, 0<z³≤3.5, 0<z³≤3.0, 0<z³≤2.5, z³ is 1.5<z³≤4.5, z³ is 1.5<z³≤4.0, z³ is 1.5<z³≤3.5, z³ is 1.5<z³≤3.0, z³ is 1.5<z³≤2.5, z³ is 2.0<z³≤4.0, z³ is 2.0<z³≤3.5, or z³ is 2.0<z³≤3.0). For example, Z is Ce, Eu, Pb, Sm, Yb, or any combination thereof, and z³ is 0<z³≤4.5 (e.g., z³ is 0<z³≤4.0, 0<z³≤3.5, 0<z³≤3.0, 0<z³≤2.5, z³ is 1.5<z³≤4.5, z³ is 1.5<z³≤4.0, z³ is 1.5<z³≤3.5, z³ is 1.5<z³≤3.0, z³ is 1.5<z³≤2.5, z³ is 2.0<z³≤4.0, z³ is 2.0<z³≤3.5, or z³ is 2.0<z³≤3.0). In other examples, Z is Ce, Sm, Yb, or any combination thereof, and z³ is 0<z³≤45 (e.g., z³ is 0<z³≤4.0, 0<z³≤3.5, 0<z³≤3.0, 0<z³≤2.5, z³ is 1.5<z³≤4.5, z³ is 1.5<z³≤4.0, z³ is 1.5<z³≤3.5, z³ is 1.5<z³≤3.0, z³ is 1.5<z³≤2.5, z³ is 2.0<z³≤4.0, z³ is 2.0<z³≤3.5, or z³ is 2.0<z³≤3.0).

In some embodiments, Q^{A} is Zr and d is 0.25<d≤1.5. In other embodiments, Q^{A} is a combination of Zr and W, d is 0.25<d≤1.5.

Some embodiments of the present invention provide a solid-state electrolyte material comprising a composition of Formula (XX-B):

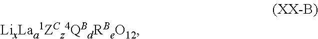

wherein
Z^{C} is Ga, Ce, Dy, Eu, Pb, Pr, Sm, Yb, or any combination thereof;
Q^{B} is Zr, W, or any combination thereof;
R^{B} is Sc, Ti, V, Cr, Mn, Fe, Co, Ni, Cu, Zn, Y, Zr, Nb, Mo, Tc, Ru, Rh, Pd, Ag, Cd, Lu, Hf, Ta, Re, Os, Ir, Pt, Au, Hg, Lr, Rf, Db, Sg, Bh, Hs, Mt, Ds, Rg, Cn, Ce, Ge, Sb, Tb, or any combination thereof;

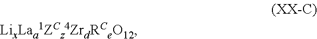

In some embodiments, Z^{C} is Ga, Ce, Dy, Eu, Pb, Pr, Sm, Yb, or any combination thereof, and z⁴ is 0.25<z⁴<2. For example, Z^{C} is Ga, Ce, Pr, Yb, or any combination thereof, and z⁴ is 0.25<z⁴<2. In other examples, Z^{C} is Ga and optionally one element selected from Pr and Yb; and z⁴ is 0.25<z⁴<2. And, in some examples, Z^{C} is Pr and optionally one element selected from Ga and Ce; and z⁴ is 0.25<z⁴<2.

Some embodiments of the present invention provide a solid-state electrolyte material comprising a composition of Formula (XX-C):

$$0 < x \leq 7 ;$$

$$0 < {a}^{1} \leq 2 \text{.25} ;$$

$$0 < {z}^{4} \leq 2 \text{.25} ;$$

$$0 < d \leq 2.5 ; and$$

$$0 < e \leq 1 .$$

wherein
Z^{C} is Ga, Ce, Dy, Eu, Pb, Pr, Sm, Yb, or any combination thereof;
R^{C} is Sc, Ti, V, Cr, Mn, Fe, Co, Ni, Cu, Zn, Y, Nb, Mo, Tc, Ru, Rh, Pd, Ag, Cd, Lu, Hf, Ta, W, Re, Os, Ir, Pt, Au, Hg, Lr, Rf, Db, Sg, Bh, Hs, Mt, Ds, Rg, Cn, Ce, Ge, Sb, Tb, or any combination thereof;

$$0 < x \leq 7 ;$$

$$0 < {a}^{1} \leq 2 \text{.25} ;$$

$$0 < {z}^{5} \leq 2 \text{.25} ;$$

$$0 < d \leq 1.5 ; and$$

$$0 < e \leq 1.5 .$$

In some embodiments, Z^{C} is Ga, Ce, Dy, Eu, Pb, Pr, Sm, Yb, or any combination thereof, and z⁴ is 0.25<z⁴<2. For example, Z^{C} is Ga, Ce, Pr, Yb, or any combination thereof, and z⁴ is 0.25<z⁴<2. In other examples, Z^{C} is Ga and optionally one element selected from Pr and Yb; and z⁴ is 0.25<z⁴<2. And, in some examples, Z^{C} is Pr and optionally one element selected from Ga and Ce; and z⁴ is 0.25<z⁴<2.

In some embodiments, R^{C} is W, Ti, V, Cr, Mn, Fe, Co, Ni, Cu, Zn, Y, Nb, Sb, or any combination thereof, and e is 0.25<e<1. For example, R^{C} is Ti, Mn, Fe, Zn, Sb, or any combination thereof, and e is 0.25<e<1. In other examples, R^{C} is Ti and optionally one element selected from Mn, Fe, or Zn; and e is 0.25<e<1. In some examples, R^{C} is Mn and optionally one element selected from Fe, Zn, or Sb; and e is 0.25<e<1. In other examples, R^{C} is Zn and optionally one element selected from Fe, Ti, or Sb; and e is 0.25<e<1. And, in some examples, R^{C} is W and optionally one element selected from Mn, Fe, or Zn; and e is 0.25<e<1.

Some embodiments of the present invention provide a solid-state electrolyte material comprising a composition of Formula (I):

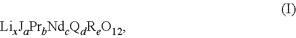

wherein,
J is H, Be, B, Al, Fe, Zn, Ga, or any combination thereof;
Q is Zr, W, or any combination thereof;
R is Sc, Ti, V, Cr, Mn, Fe, Co, Ni, Cu, Zn, Y, Zr, Nb, Mo, Tc, Ru, Rh, Pd, Ag, Cd, Lu, Hf, Ta, Re, Os, Ir, Pt, Au, Hg, Lr, Rf, Db, Sg, Bh, Hs, Mt, Ds, Rg, Cn, Ce, Ge, Sb, Tb, or any combination thereof;

$$0 < x \leq 7 ;$$

$$0 \leq a \leq 1 ;$$

$$0 < b \leq 3.5 ;$$

$$0 \leq c \leq 1 ;$$

$$0 < d \leq 2.5 ;$$

$$and$$

$$0 \leq e \leq 1 .$$

In some embodiments, J is H. In other embodiments, J is Be. In some embodiments, J is B. In other embodiments, J is Fe. And, in some embodiments, J is Zn.

In some embodiments, J is Al, Ga, or any combination thereof. In other embodiments, J is Al. And, in some embodiments, J is Ga.

In some embodiments, Q is Zr or W. In other embodiments, Q is Zr. And, in some embodiments, Q is W. And, in some embodiments, Q is a combination of Zr and W.

In some embodiments, R is Sc. In other embodiments, R is Ti. In some embodiments, R is V. In some embodiments, R is Mn. In other embodiments, R is Fe. In some embodiments, R is Co. In some embodiments, R is Ni. In some embodiments, R is Cu. In other embodiments, R is Zn. In some embodiments, R is Y. In some embodiments, R is Zr. In some embodiments, R is Mo. In other embodiments, R is Tc. In some embodiments, R is Ru. In some embodiments, R is Rh. In some embodiments, R is Pd. In other embodiments, R is Ag. In some embodiments, R is Cd. In some embodiments, R is Lu. In some embodiments, R is Hf. In other embodiments, R is Ta. In some embodiments, R is W. In some embodiments, R is Re. In some embodiments, R is Os. In other embodiments, R is Jr. In some embodiments, R is Pt. In some embodiments, R is Au. In some embodiments, R is Hg. In other embodiments, R is Lr. In some embodiments, R is Rf. In some embodiments, R is Db. In some embodiments, R is Sg. In other embodiments, Bh. In some embodiments, R is Hs. In some embodiments, R is Mt. In some embodiments, R is Ds. In other embodiments, R is Rg. In some embodiments, R is Cn.

In some embodiments, R is Nb, Ce, Cr, or any combination thereof. For example, R may be Nb. In other embodiments, R is Ce. And, in some embodiments, R is Cr.

In some embodiments, 2.5<x≤7. In other embodiments, 2.5<x≤6.7. In some embodiments 1<x≤5. In some embodiments, 1.5<x<4.5. In some embodiments, 2≤x≤4. In some embodiments, 2.75<x<3.25. In other embodiments, 5<x≤7. In some embodiments, 6<x≤7. In some embodiments, 6<x≤6.7. In other embodiments, 6.2≤x≤6.8. In some embodiments, x is about 6.2, 6.4, or 6.6. In other embodiments, x is about 6.2. In other embodiments, x is about 6.4. In some embodiments, x is about 6.6. And, in some embodiments, x is about 3.

In some embodiments, 0≤a≤0.7. In other embodiments, 0<a<0.7. In some embodiments, 0<a<0.5. In some embodiments, 0<a<0.4. In some embodiments, 0<a<0.3. In some embodiments, 0.1<a<0.3. In some embodiments, a is about 0.2. And, in some embodiments, a is 0.

In some embodiments, 1<b<3.5. In other embodiments, 2<b<3.5. In some embodiments, 2.25<b<3.25. In some embodiments, 2.5≤b<3.5. In some embodiments, 2.5≤b<3.25. In other embodiments, b is about 2.5. In some embodiments, b is about 3.

In some embodiments, 0≤c<1. In other embodiments, 0≤c<0.8. In some embodiments, 0<c<0.8. In some embodiments, 0<c<0.6. In some embodiments, 0.3<c<0.7. In some embodiments, 0.4<c<0.6. In other embodiments, c is 0. And, in some embodiments, c is about 0.5.

In some embodiments, 0<d≤2. In other embodiments, 1<d<2.5. In some embodiments, 1.5<d<2.5. In some embodiments, 1<d<2.25. In some embodiments, 1.5<d≤2.0. In other embodiments 1.5<d<2.0. In some embodiments, 1.6<d<1.9. In some embodiments, d is about 2. And, in some embodiments, d is about 1.8.

In some embodiments, 0<e≤0.75. In other embodiments, 0<e≤0.5. In some embodiments, 0<e<0.5. In some embodiments, 0<e<0.4. In some embodiments, 0<e≤0.3. In other embodiments, 0<e<0.3. In some embodiments, 0.1<e<0.3. In some embodiments, e is about 0.2. And, in some embodiments, e is 0.

Some embodiments of the present invention provide a solid-state electrolyte material comprising a composition of a formula of a formula selected from
Li_{6.2}Ga_{0.2}Pr₃Zr_{1.8}Nb_{0.2}O₁₂;
Li_{6.4}Ga_{0.2}Pr₃Zr_{1.8}Ce_{0.2}O₁₂;
Li_{6.4} Ga_{0.2}Pr_{2.5}Nd_{0.5}Zr₂O₁₂;
Li_{6.6}Ga_{0.2}Pr₃Zr_{1.8}Cr_{0.2}O₁₂; or
Li₃Pr_{2.5}Nd_{0.5}W₂O₁₂.

In some embodiments, the solid-state electrolyte material comprising a composition of the formula Li_{6.2}Ga_{0.2}Pr₃Zr_{1.8}Nb_{0.2}O₁₂. In other embodiments, the solid-state electrolyte material comprising a composition of the formula Li_{6.4}Ga_{0.2}Pr₃Zr_{1.8}Ce_{0.2}O₁₂. In some embodiments, the solid-state electrolyte material comprising a composition of the formula Li_{6.4}Ga_{0.2}Pr_{2.5}Nd_{0.5}Zr₂O₁₂. In some embodiments, the solid-state electrolyte material comprising a composition of the formula Li_{6.6}Ga_{0.2}Pr₃Zr_{1.8}Cr_{0.2}O₁₂. And, in some embodiments, the solid-state electrolyte material comprising a composition of the formula Li₃Pr_{2.5}Nd_{0.5}W₂O₁₂.

Other embodiments of the present invention provide a solid-state electrolyte material comprising a composition of Formula (Ia):

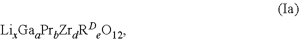

wherein R^{D} is W, Sc, Ti, V, Cr, Mn, Fe, Co, Ni, Cu, Zn, Y, Zr, Nb, Mo, Tc, Ru, Rh, Pd, Ag, Cd, Lu, Hf, Ta, Re, Os, Ir, Pt, Au, Hg, Lr, Rf, Db, Sg, Bh, Hs, Mt, Ds, Rg, Cn, Ce, Ge, Sb, Tb, or any combination thereof, and x, a, b, d, and e are as defined in the composition of Formula (I), or any embodiment thereof.

In some embodiments, R^{D} is W, Sc, Ti, V, Cr, Mn, Fe, Co, Ni, Cu, Zn, Y, Zr, Nb, Mo, Tc, Ru, Rh, Pd, Ag, Cd, Lu, Hf, Ta, W, Re, Os, Ir, Pt, Au, Hg, Lr, Rf, Db, Sg, Bh, Hs, Mt, Ds, Rg, Cn, Ce, Ge, Sb, Tb, or any combination thereof. In other embodiments, R¹ is W, Nb, Ce, Cr, or any combination thereof. For example, R is Nb. In other embodiments, R^{D} is Ce. In some embodiments, R^{D} is W. And, in some embodiments, R^{D} is Cr.

In some embodiments,

$$0 < x \leq 7 ;$$

$$0 \leq a \leq 1 ;$$

$$0 < b \leq 3.5 ;$$

$$0 < d \leq 2.5 ;$$

$$and$$

$$0 \leq e \leq 1 .$$

In some embodiments,

$$6 < x < 7 ;$$

$$0 < a < 1 ;$$

$$2. < b < 3.5 ;$$

$$1 < d < 2 ;$$

$$and$$

$$0 < e < 0.5 .$$

In some embodiments, 6.2≤x≤6.8. In other embodiments, x is about 6.2, 6.4, or 6.6. In some embodiments, x is about 6.2. In some embodiments, x is about 6.4. And, in some embodiments, x is about 6.6.

In other embodiments, 0<a<0.3. In other embodiments, 0.1<a<0.3. And, in some embodiments, a is about 0.2.

In some embodiments, 2.25<b<3.25. In other embodiments, 2.75<b<3.25. And, in some embodiments, b is about 3.

In some embodiments, 1.5<d<2.25. In other embodiments. 1.6<d<1.9. And, in some embodiments, d is about 1.8.

In some embodiments, 0<e<0.3. In other embodiments, 0.1<e<0.3. And, in some embodiments, e is about 0.2

Some embodiments of the present invention provide a solid-state electrolyte material comprising a composition of Formula (Ib):

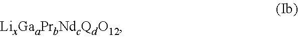

wherein Q, x, a, b, c, and d are as defined in the composition of Formula (I), or any embodiment thereof.

In some embodiments, Q is W, Zr, or any combination thereof. In other embodiments, Q is W or Zr. In some embodiments, Q is W. In some embodiments, Q is Zr. And, in some embodiments, Q is a combination of W and Zr.

In some embodiments,

$$0 < x \leq 7 ;$$

$$0 \leq a \leq 1 ;$$

$$0 < b \leq 3.5 ;$$

$$0 \leq c \leq 1 ;$$

$$and$$

$$0 < d \leq 2.5 .$$

In some embodiments,

$$2.5 < x < 7 ;$$

$$0 \leq a < 0.5 ;$$

$$2 < b < 3 ;$$

$$0 < c < 1 ;$$

$$and$$

$$0 < d \leq 2 .$$

In some embodiments,
Q is W; and
a is 0.

In some embodiments, is 2.5<x<3.5. In other embodiments, 2.75<x<3.25. And, in some embodiments, x is about 3.

In some embodiments,
Q is Zr; and
0<a<0.5.

In some embodiments, 6.2≤x≤6.8. In other embodiments, x is about 6.2, 6.4, or 6.6. And, in some embodiments, x is about 6.4.

Unless otherwise stated, each subscript in any chemical formula set forth herein is significant to the hundredths place, and a range of subscripts includes each hundredths value between the upper and lower boundaries of the range. For example, the range 0<x<1 includes 0.01, 0.02, through 0.98, and 0.99.

Unless otherwise stated, when any (e.g., Z, Z^{A}, Z^{B}, Z^{C}, I¹, J, J¹, K¹, L¹, Q, Q^{A}, Q^{B}, Q^{C}, R, R^{A}, R^{B}, R^{C}, and the like) of any chemical formula set forth herein is a combination of different elements (e.g., Li, Na, and K), a combination of different types of cations (Li⁺, Na⁺, or K⁺), or a combination of different types of anions (e.g., Cl⁻, Br⁻, and I⁻), the subscript immediately following such constituent (e.g., x, y, z, a, b, c, d, e, z1, z2, z³, z⁴ and the like) represents the aggregate pfu for all elements, types of cations, or types of anions in the combination. And, when any constituent (e.g., Z, Z^{A}, Z^{B}, Z^{C}, I¹, J, J¹, K¹, L¹, Q, Q^{A}, Q^{B}, Q^{C}, R, R^{A}, R^{B}, R^{C}, and the like) of any chemical formula set forth herein is a single element (e.g., Li, Na, or K), a single type of cation (Li⁺, Na⁺, or K⁺), or a single type of anion (e.g., Cl⁻, Br⁻, or I⁻), the subscript immediately following such constituent (e.g., x, y, z, a, b, c, d, e, z1, z2, z³, z⁴ and the like) represents the aggregate pfu for such element, type of cation, or type of anion.

In some embodiments, the solid-state electrolyte material comprising a composition of Formula (XX), (XX-A), (XX-B), (XX-C), (I), (Ia), and/or (Ib) is ion conducting and electron conducting.

For example, the solid-state electrolyte material may have a lithium ion conductivity of at least about 0.01 mS/cm. In some embodiments, the solid-state electrolyte material may have a lithium ion conductivity of at least about 0.05 mS/cm. In other embodiments, the solid-state electrolyte material may have a lithium ion conductivity of at least about 0.075 mS/cm. In some embodiments, the solid-state electrolyte material has a lithium ion conductivity of at least about 0.09 mS/cm. And, in some embodiments, the solid-state electrolyte material has a lithium ion conductivity of at least about 0.11 mS/cm.

In other embodiments, the solid-state electrolyte material has a lithium ion conductivity of from about 0.001 mS/cm to about 1 mS/cm. In some embodiments, the solid-state electrolyte material has a lithium ion conductivity of from about 0.01 mS/cm to about 0.50 mS/cm. In some embodiments, the solid-state electrolyte material has a lithium ion conductivity of from about 0.05 mS/cm to about 0.30 mS/cm. And, in some embodiments, the solid-state electrolyte material has a lithium ion conductivity of from about 0.05 mS/cm to about 0.20 mS/cm.

In some embodiments, the solid-state electrolyte material has an electron conductivity of at least about 0.10 μS/cm. In other embodiments, the solid-state electrolyte material has an electron conductivity of at least about 0.50 μS/cm. In some embodiments, the solid-state electrolyte material has an electron conductivity of at least about 1 μS/cm. In other embodiments, the solid-state electrolyte material has an electron conductivity of at least about 2.50 μS/cm. In some embodiments, the solid-state electrolyte material has an electron conductivity of at least about 5 μS/cm. In some embodiments, the solid-state electrolyte material has an electron conductivity of at least about 7.50 μS/cm. And, in some embodiments, the solid-state electrolyte material has an electron conductivity of at least about 10 μS/cm.

In some embodiments, the solid-state electrolyte material has an electron conductivity of from about 0.10 μS/cm to about 100 μS/cm. For example, the solid-state electrolyte material may have an electron conductivity of from about 0.10 μS/cm to about 50 μS/cm. In other embodiments, the solid-state electrolyte material has an electron conductivity of from about 1 μS/cm to about 25 μS/cm. And, in some embodiments, the solid-state electrolyte material has an electron conductivity of from about 1 μS/cm to about 15 μS/cm.

In some embodiments, the solid-state electrolyte material has an ambipolar conductivity of at least about 0.10 μS/cm. In other embodiments, the solid-state electrolyte material has an ambipolar conductivity of at least about 0.50 μS/cm. In some embodiments, the solid-state electrolyte material has an ambipolar conductivity of at least about 1 μS/cm. In other embodiments, the solid-state electrolyte material has an ambipolar conductivity of at least about 2.5 μS/cm. In some embodiments, the solid-state electrolyte material has an ambipolar conductivity of at least about 5 μS/cm. In some embodiments, the solid-state electrolyte material has an ambipolar conductivity of at least about 7.5 μS/cm. And, in some embodiments, the solid-state electrolyte material has an ambipolar conductivity of at least about 9 μS/cm.

In some embodiments, the solid-state electrolyte material has an ambipolar conductivity of from 0.10 μS/cm to about 100 μS/cm. For example, the solid-state electrolyte material may have an ambipolar conductivity of from about 0.10 μS/cm to about 50 μS/cm. In other embodiments, the solid-state electrolyte material has an ambipolar conductivity of from about 1 μS/cm to about 25 μS/cm. And, in some embodiments, the solid-state electrolyte material has an ambipolar conductivity of from about 1 μS/cm to about 15 μS/cm.

In some embodiments, the solid-state electrolyte material is sintered. In some embodiments, the sintered solid-state electrolyte material is incorporated into a ceramic separator. In some embodiments, the sintered solid-state electrolyte material is incorporated into a host structure for lithium metal plating and stripping. In some embodiments, the sintered solid-state electrolyte material is in physical contact with a cathode material and anode material, forming a combined electrode pair and separator layer.

Another aspect of the present invention provides an electrode for a solid-state battery. The electrode comprises a solid-state electrolyte material. The solid-state electrolyte material comprises a composition of Formula (XX), (XX-A), (XX-B), (XX-C), (I), (Ia), and/or (Ib).

Another aspect of the present invention provides a bilayer solid-state electrolyte structure. The bilayer solid-state electrolyte structure comprises a porous layer and a dense layer. At least one of the porous layer and the dense layer comprises a solid-state electrolyte material comprising a composition of Formula (XX), (XX-A), (XX-B), (XX-C), (I), (Ia), and/or (Ib). In some embodiments, the porous layer comprises the solid-state electrolyte material. In other embodiments, the dense layer comprises the solid-state electrolyte material. And, in some embodiments, the porous layer and the dense layer each independently comprise the solid-state electrolyte material.

In another aspect, the present invention provides a bilayer solid-state electrolyte structure. The bilayer solid-state electrolyte structure comprises a porous layer and a dense layer. The porous layer comprises a first solid-state electrolyte material, wherein the first solid-state electrolyte material is ion conducting and electron conducting (e.g., the solid-state electrolyte material comprises a composition of Formula (XX), (XX-A), (XX-B), (XX-C), (I), (Ia), and/or (Ib)). The dense layer comprises a second solid-state electrolyte material that is different from the first solid-state electrolyte material. In some embodiments, the second solid-state electrolyte material is ion conducting. In other embodiments, the second solid-state electrolyte material is electron conducting. And, in some embodiments, the second solid-state electrolyte material is ion conducting and electron conducting.

Another aspect of the present invention provides a trilayer solid-state electrolyte structure. The trilayer solid-state electrolyte structure comprises a first porous layer, a dense layer, and second porous layer. At least one of the first porous layer, the dense layer, and the second porous layer comprises a solid-state electrolyte material comprising a composition of Formula (XX), (XX-A), (XX-B), (XX-C), (I), (la), and/or (Ib). In some embodiments, the dense layer is disposed between the first and second porous layers. In some embodiments, at least one of the first porous layer and the second porous layer comprises the solid-state electrolyte material. In other embodiments, the first porous layer and the second porous layer each independently comprise the solid-state electrolyte material. In some embodiments, the dense layer comprises the solid-state electrolyte material. And, in some embodiments, the first porous layer, the dense layer, and the second porous layer each independently comprise the solid-state electrolyte material.

Another aspect of the present invention provides a trilayer solid-state electrolyte structure. The trilayer solid-state electrolyte structure comprises a first porous layer, a dense layer, and second porous layer. At least one of the first porous layer and the second porous layer comprises a first solid-state electrolyte material, wherein the first solid-state electrolyte material is ion conducting and electron conducting (e.g., the solid-state electrolyte material comprises a composition of Formula (XX), (XX-A), (XX-B), (XX-C), (I), (Ia), and/or (Ib)). The dense laver is disposed between the first and second porous layers. The dense layer comprises a second solid-state electrolyte material that is different from the first solid-state electrolyte material. In some embodiments, the second solid-state electrolyte material is ion conducting. In other embodiments, the second solid-state electrolyte material is electron conducting. And, in some embodiments, the second solid-state electrolyte material is ion conducting and electron conducting.

Another aspect of the present invention provides a solid-state battery comprising a solid-state electrolyte material as described herein, an electrode as described herein, a bilayer solid-state electrolyte structure as described herein, or a trilayer solid-state electrolyte structure as described herein.

### III. Methods of Forming a Green Body

In another aspect, the present invention provides a method of forming a green body. The method comprises:
(a) reacting a precursor mixture to form a solid-state electrolyte material described herein;
(b) dispersing the solid-state electrolyte material in a solvent to form a dispersed material;
(c) casting the dispersed material on a substrate to form the green body.

In some implementations, the reacting step (a) comprises calcining the precursor mixture. In some implementations, the calcining is performed at a temperature of from about 600° C. to about 1,200° C. In other implementations, the calcining is performed at a temperature of from about 700° C. to about 1,100° C. In some implementations, the calcining is performed at a temperature of from about 800° C. to about 1,000° C. And, in some implementations, the calcining is performed at a temperature of about 900° C.

In some implementations, the calcining is performed for at least about 1 minute. In other implementations, the calcining is performed for at least about 1 hour. In some implementations, the calcining is performed for at least about 5 hours. And, in some implementations, the calcining is performed for at least about 10 hours.

In some implementations, the reacting step (a) further comprises
(a-1) reacting a precursor mixture to form a solid-state electrolyte material; and
(a-2) milling the solid-state electrolyte material to increase uniformity and reduce particle size.

In some implementations, milling step (a-2) is performed prior to dispersing the solid-state electrolyte material (i.e., step (b)).

In some implementations, the method further comprises (d) mixing the solid-state electrolyte material or the dispersed material with at least one of a binder, a plasticizer, and a pore-forming agent.

For example, step (d) may comprise mixing the solid-state electrolyte material with a binder. In other implementations, step (d) comprises mixing the solid-state electrolyte material with a plasticizer. In some implementations, step (d) comprises mixing the solid-state electrolyte material with a pore-forming agent. In some implementations, step (d) comprises mixing the solid-state electrolyte material with a binder and a plasticizer. And, in some implementations, step (d) comprises mixing the solid-state electrolyte material with a binder, a plasticizer, and a pore-forming agent.

In some implementations, step (d) comprises mixing the dispersed material with a binder. In other implementations, step (d) comprises mixing the dispersed material with a plasticizer. In some implementations, step (d) comprises mixing the dispersed material with a pore-forming agent. In some implementations, step (d) comprises mixing the dispersed material with a binder and a plasticizer. And, in some implementations, step (d) comprises mixing the dispersed material with a binder, a plasticizer, and a pore-forming agent.

Another aspect of the present invention provides a method of forming a sintered solid-state electrolyte. The method comprises forming a green body according to any method described herein. The method also comprises sintering the green body to form the sintered solid-state electrolyte.

In some implementations, the step of sintering is performed at a temperature of less than or equal to about 1,200° C. For example, the step of sintering may be performed at a temperature of from about 900° C. to about 1,200° C. In some implementations, the step of sintering is performed for about 1 minute to about 10 hours. For example, the sintering step may be performed for about 4 hours to about 10 hours. And, in some implementations, the step of sintering is performed for about 8 hours.

### IV. Examples

In order that the invention described herein may be more fully understood, the following examples are set forth. The examples described in this application are offered to illustrate the methods and MIEC solid-state electrolyte materials provided herein and are not to be construed in any way as limiting their scope.

### Example 1: Synthesis and Characterization of Mixed Ion and Electron Conducting (MIEC) Solid-State Electrolyte Materials

MIEC solid-state electrolyte materials with nominal composition Li_{6.2}Ga_{0.2}Pr₃Zr_{1.8}Nb_{0.2}O₁₂, Li_{6.4}Ga_{0.2}Pr₃Zr_{1.8}Ce_{0.2}O₁₂, Li_{6.4}Ga_{0.2}Pr_{2.5}Nd_{0.5}Zr₂O₁₂, and Li_{6.6}Ga_{0.2}Pr₃Zr_{1.8}Cr_{0.2}O₁₂ were prepared via solid-state reactions.

For the preparation of Li_{6.2}Ga_{0.2}Pr₃Zr_{1.8}Nb_{0.2}O₁₂, an appropriate amount of lithium hydroxide monohydrate (i.e., 10 wt. % excess LiOH·H₂O was added to compensate possible lithium loss during high temperature sintering), praseodymium nitrate, gallium oxide, zirconium oxide, and niobium oxide were weighed and wet ball milled in iso-propanol using zirconia milling media.

For each of Li_{6.4}Ga_{0.2}Pr₃Zr_{1.8}Ce_{0.2}O₁₂, Li_{6.4}Ga_{0.2}Pr_{2.5}Nd_{0.5}Zr₂O₁₂, and Li_{6.6}Ga_{0.2}Pr₃Zr_{1.8}Cr_{0.2}O₁₂, cerium oxide was added as a precursor material for cerium doping, neodymium oxide was added as a precursor material for neodymium doping, and chromium oxide was added as a precursor material for chromium doping. Each transition metal dopant was added with the precursor materials of lithium hydroxide monohydrate, praseodymium nitrate, gallium oxide, and zirconium oxide. The materials were then wet ball milled in iso-propanol using zirconia milling media.

After the evaporation of solvent, the collected powders of Li_{6.2}Ga_{0.2}Pr₃Zr_{1.8}Nb_{0.2}O₁₂, Li_{6.4}Ga_{0.2}Pr_{2.5}Nd_{0.5}Zr₂O₁₂, and Li_{6.6}Ga_{0.2}Pr₃Zr_{1.8}Cr_{0.2}O₁₂ were annealed at 950° C. for 10 hours and cooled to room temperature. Li₆_4Ga_{0.2}Pr₃Zr_{1.8}Ce_{0.2}O₁₂ was annealed at 800° C. for 10 hours, and the resultant annealed powder was wet ball milled for 24 hours, then dried.

The dried powder of Li_{6.2}Ga_{0.2}Pr₃Zr_{1.8}Nb_{0.2}O₁₂, Li_{6.4}Ga_{0.2}Pr_{2.5}Nd_{0.5}Zr₂O₁₂, and Li_{6.6}Ga_{0.2}Pr₃Zr_{1.8}Cr_{0.2}O₁₂ was pressed into pellets and placed on magnesium oxide plates with a sufficient amount of mother powder covering the pellet to minimize lithium loss during sintering at 1,100° C. for 8 hours. Li_{6.4}Ga_{0.2}Pr₃Zr_{1.8}Ce_{0.2}O₁₂ pellets were sintered at 1,050° C. for 8 hours. After sintering, the resultant pellets were polished with 600 and 1200 grit sandpaper, and then cleaned with ethanol.

The crystal phase of each of the synthesized powders was analyzed using powdered X-ray diffraction with a Bruker D8 advance diffractometer. The phase analysis of the samples was done using a Cu Kα radiation of λ=1.5418 Å in the 2Θ range from 10 to 70°. Scanning Electron Microscope (SEM) images were captured with a Tescan GALA FEG.

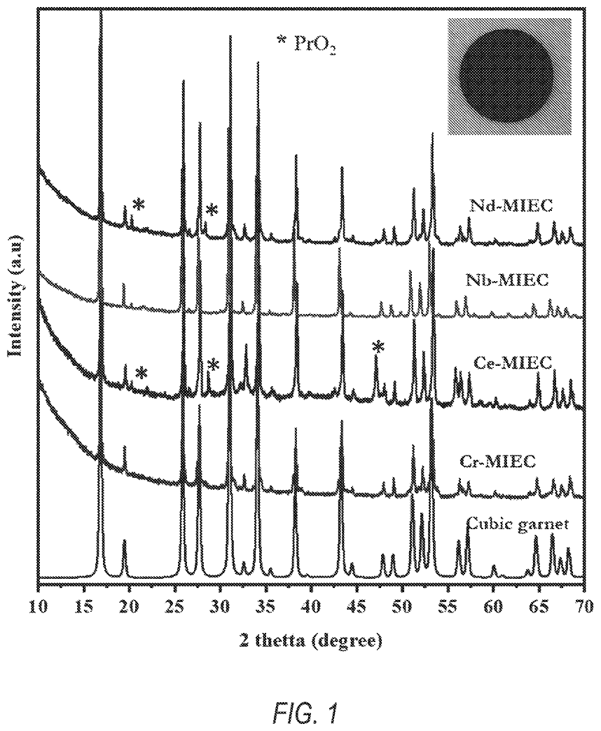

FIG. 1 shows the powdered X-ray diffraction pattern of the various MIEC solid-state electrolyte materials along with a Li₇La₃Zr₂O₁₂ (LLZO) cubic garnet. Among the MIEC solid-state electrolyte materials, Li_{6.2}Ga_{0.2}Pr₃Zr_{1.8}Nb_{0.2}O₁₂ (Nb-MIEC) and Li_{6.6}Ga_{0.2}Pr₃Zr_{1.8}Cr_{0.2}O₁₂ (Cr-MIEC) have a single-phase garnet like structure that matched well with the LLZO cubic garnet phase, with space group Ia3-d indicating that the compounds are isostructural. For other MIEC solid-state electrolyte materials (i.e., Li_{6.4}Ga_{0.2}Pr₃Zr_{1.8}Ce_{0.2}O₁₂ (Ce-MIEC) and Li_{6.4}Ga_{0.2}Pr_{2.5}Nd_{0.5}Zr₂O₁₂ (Nd-MIEC)), the primary phase matched well with the LLZO cubic garnet phase, but a minor secondary phase of PrO₂ was also observed. This secondary phase of PrO₂ was attributed to the conversion of Pr³⁺ to Pr⁴⁺, leading to the incomplete reaction of PrO₂ with other elements. Compared to the LLZO cubic garnet, the peaks of the MIEC lithium garnets were shifted towards a higher angle because of the dopants used. Further, and as shown in the inset image of FIG. 1, it was observed that all prepared MIEC solid-state electrolyte materials exhibited a noticeable black color. This black color may be due to the mixed valence state of Pr (3+ and 4+).

### Example 2: Ionic and Electronic Conductivity of MIEC Solid-State Electrolyte Materials and a Comparative Solid-State Electrolyte Material

Comparative solid-state electrolyte material: For the comparative solid-state electrolyte material (Li_{6.75}La₃Zr_{1.75}Ta_{0.25}O₁₂Ta-doped LLZO), stoichiometric amounts of lithium hydroxide monohydrate with 10 wt. % excess, tantalum oxide, zirconium oxide, and preheated lanthanum oxide were wet ball-milled using iso-propanol. The sample was then dried and calcined at 900° C. for 10 hours in a magnesium oxide crucible. The calcined powder was ball-milled again and then dried and pressed into pellets with sufficient mother powder covering the pellets before sintering at 1,100° C. for 8 hours. Once the sintering process was complete, the sintered pellets were retrieved from the mother powder and polished using SiC sheets of different grit size (#600-#1200).

The electrical conductivity and galvanostatic cycling of the MIEC solid-state electrolyte material pellets and Ta-doped LLZO pellets were performed with a Biologic VMP 300 Potentiostat using an Arbin battery tester. Before the electrochemical measurements, the pellets were polished with a SiC sheet having a grit size #600, followed by #1200, in iso-propanol media. After rinsing and drying, gold was painted on each side of the pellets and cured at 700° C. for 3 hours. Ionic conductivities were measured at room temperature using a 50 mV perturbation voltage at a frequency of from 1 Hz to 1 MHz. The electronic conductivities were measured using chronoamperometry with a potential of 2 V versus the open-circuit voltage.

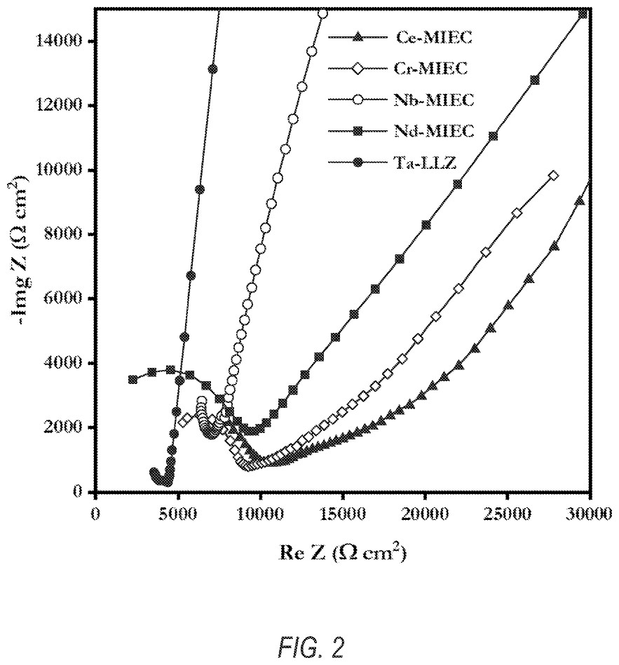

To investigate the influence of different transition metals on the ionic conductivity of the solid-state electrolyte materials, electrochemical impedance spectroscopy (EIS) was conducted at room temperature. The Nyquist plot of the MIEC solid-state electrolyte materials and Ta-doped lithium garnet (Li_{6.75}La₃Zr_{1.75}Ta_{0.25}O₁₂) is shown in FIG. 2. The characteristics of all curves are similar, including a semicircle at higher frequency regime and a Warburg element at lower frequency regime. The semicircle at higher frequency corresponds to the grain and grain boundary resistance. A merged semicircle, instead of two distinct semi-circles, was observed because of tight grain connections. The total lithium-ion conductivity (grain+grain boundary) of each sample was calculated from the inverse of the resistivity derived from the intercept of the semicircle with the real axis. The Warburg element at lower frequency indicates charge-transfer and diffusion of lithium ions to Au. The calculated lithium ion conductivity of the Ta-doped LLZO was 0.23 mS/cm. In comparison to the Ta-doped LLZO, the lithium ion conductivity decreased for the MIEC solid-state electrolyte materials. The lithium ion conductivity of Nb-MIEC, Nd-MIEC, Cr-MIEC, and Ce-MIEC was 0.136 mS/cm, 0.104 mS/cm, 0.11 mS/cm, and 0.092 mS/cm, respectively.

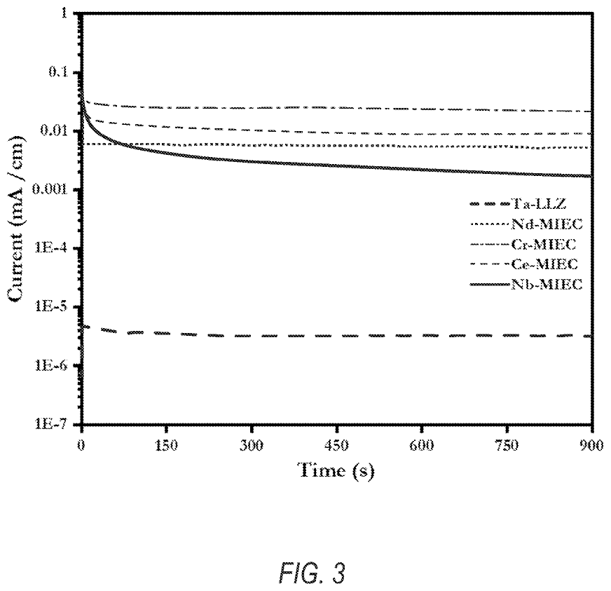

To determine the electronic conductivity of solid-state electrolyte materials, chronoamperometry was performed using Au electrodes on both sides. A constant voltage of 2 V was applied to the cell configuration and the corresponding current response was studied with respect to time. FIG. 3 shows the current response of the MIEC solid-state electrolyte materials and the Ta-doped LLZO. In this configuration, the initial current response represents both lithium ion and electron transport. However, with time the current response decreases drastically, since there is no source of lithium ions from the electrodes, and the residual current is purely electronic. Electronic conductivity was measured according to formula (2):

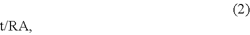

wherein,
t is the thickness of the sample:
R is the electronic resistance of the sample which is determined from the chronoamperometry measurement; and
A is the area of the electrode.
   With continued reference to FIG. 3, the Ta-doped LLZO exhibited a residual current in the range of nanoamps (nA) while the MIEC solid-state electrolyte materials exhibited residual current in the range of microamps (μA). The increase in the residual current is a direct indication of high electronic conductivity in the MIEC solid-state electrolyte materials. The electronic conductivity measured for Ta-doped LLZO was 1.6 nS/cm. For Nb-MIEC, Nd-MIEC, Cr-MIEC, and Ce-MIEC, the measured electronic conductivity was 1.16 μS/cm, 2.6 μS/cm, 10.2 μS/cm, and 4.5 μS/cm, respectively.

Additionally, the comprehensive performance of the MIEC solid-state electrolyte materials and Ta-doped LLZO were assessed by the ambipolar conductivity. For all of the solid-state electrolyte materials, the lithium-ion conductivity is predominant over electronic conductivity. Therefore, a solid-state electrolyte material with a higher electronic conductivity has a comparatively higher ambipolar conductivity. The ambipolar conductivity of Ta-doped LLZO, Nb-MIEC, Nd-MIEC, Cr-MIEC, and Ce-MIEC was 1.6 nS/cm, 1.15 μS/cm, 2.53 μS/cm, 9.8 μS/cm, and 4.3 μS/cm respectively.

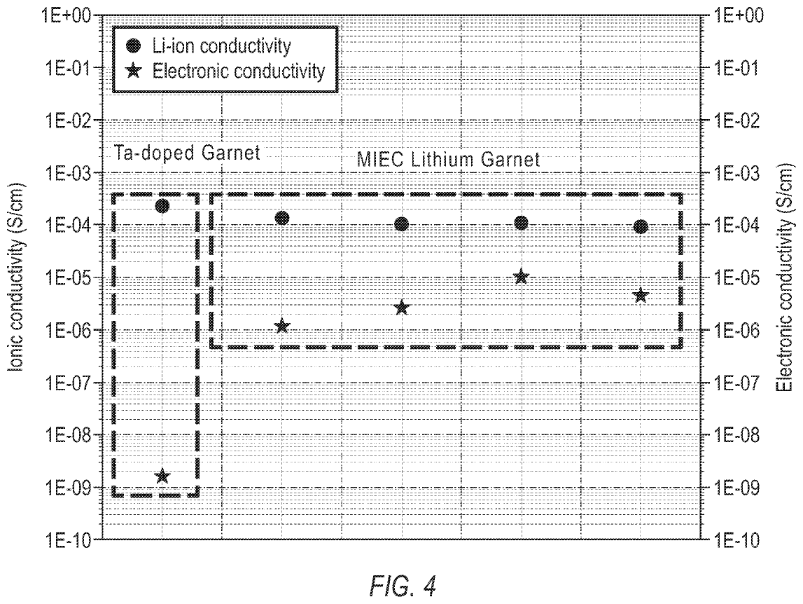

FIG. 4 shows a comparison of the ionic and electronic conductivity of the Ta-doped LLZO and the MIEC solid-state electrolyte materials. The Ta-doped LLZO exhibited an ionic conductivity of 10⁻⁴ S/cm and an electronic conductivity of 10⁻¹⁰ S/cm, which is consistent with other reported values. However, the MIEC solid-state electrolyte materials had ionic conductivities in the range of from 10⁻⁴ S/cm to 10⁻⁶ S/cm, and electronic conductivities in the range of 10⁻⁵ S/cm to 10⁻⁶ S/cm, depending on the transition metal doping on the Zr site. Thus, MIEC solid-state electrolyte materials can be used as a single percolative network in “Li-free” anodes and composite cathodes of solid-state lithium batteries.

### Example 3: Fabrication of a Lithium Symmetric Cell Comprising an MIEC Solid-State Electrolyte Material

Synthesis of Trilayer Lithium Garnet Structure: For the dense layer, The Ta-doped LLZO (30 wt %), isopropanol (26 w t %), and toluene (26 wt %) were milled together with yttria-stabilized zirconia grinding spheres for 24 hours. Benzyl butyl phthalate (4 wt %), polyalkylene glycol (4 wt %), and polyvinyl butryl (8 wt %) were added, and the resultant mixture was milled for another 24 hours. For the porous layer, an MIEC solid-state electrolyte material (Li_{6.4}Ga_{0.2}Pr₃Zr_{1.8}Ce_{0.2}O₁₂; Ce-MIEC) powder was used, and 10 μm cross-linked poly(methyl methacrylate) (PMMA) spheres (18 wt %) were added and milled for an hour before tape casting. The slurries were cast at 10 cm/min through a doctor blade onto a mylar sheet. The dense layer was cast with a thickness of 156 μm, and the porous layer was cast with a thickness of 305 μm. The trilayer structure was formed by laminating the tapes together by pressing at 170 psi and 60° C. for 30 minutes. The trilayer structure was then removed from the mylar sheet and cut into squares using a laser cutter. The trilayer squares were then placed on a light layer of mother powder on a magnesium plate. These structures were then sintered at 1050° C. for 3 hours in a tube furnace.

Fabrication of the lithium symmetric cell: After sintering, the trilayer structure was placed in an atomic laver deposition (ALD) chamber that was integrated into an argon filled glove box. Zinc oxide (˜4 nm) was deposited via ALD (Forge Nano Inc.) into the porous layers. After, ALD, lithium metal was cleaned and melted on a stainless steel current collector. The trilayer structure was stacked and heated on a hot plate at 240° C. to impregnate lithium into the porous layer to create a symmetric cell. After cooling, the assembly was sealed in a 2032 coin cell. This procedure was carried out in an argon filled glove box (<0.1 ppm O₂, H₂O).

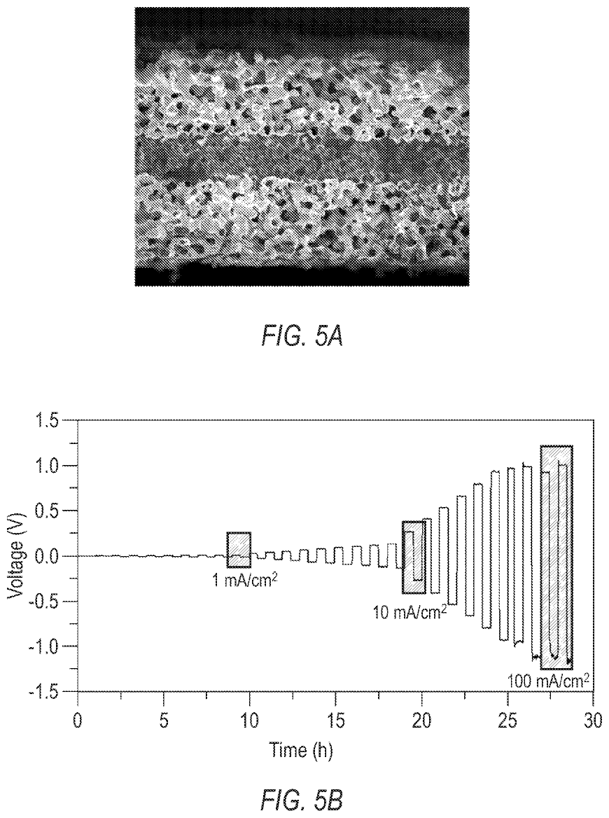

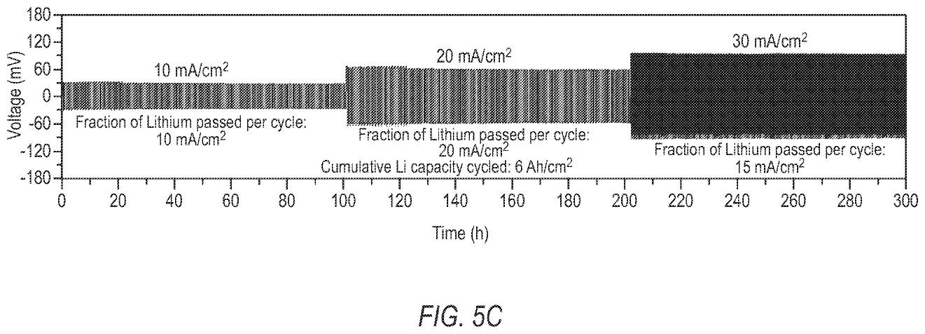

As set forth above, the trilayer (porous-dense-porous) architecture was fabricated with a thin dense middle layer made of the Ta-doped LLZO and porous layers made of the MIEC solid-state electrolyte material (FIG. 5A). The dense layer, without any gaps between the grains, is free from structural defects making it suitable for blocking dendrite growth. The outer layer is porous with a continuous 3D network of MIEC solid-state electrolyte material for lithium ion and electron conduction pathways across the cell, making it suitable for electrode filling. The dense layer had a thickness of ˜20 μm and the porous layer had a thickness of ˜35 μm.

To explore the electrochemical properties of the trilayer architecture, lithium was infiltrated inside both MIEC porous layers. The critical current density assessment of the symmetric cell was conducted with different current densities starting from 0.1 mA/cm² to 100 mA/cm², as shown in FIG. 5B. The symmetric cell showed no short-circuit, even at 100 mA/cm², demonstrating the effectiveness of the MIEC solid-state electrolyte material porous layer in increasing the critical current density 10× over previous cells that did not incorporate the MIEC solid-state electrolyte material in the porous layers. Materials Today, 22, 50-57, 2019. The critical current density attained is the highest value obtained for a garnet solid-state electrolyte at room temperature (22° C.) without any stack pressure.

FIG. 5C shows the results of galvanostatically cycling the symmetric cell at a current density of 10 mA/cm², 20 mA/cm² and 30 mA/cm², and at a cycling depth of 10 mAh/cm², 20 mAh/cm², and 15 mAh/cm², respectively, for 300 h. The current density at which the cells were cycled and the cycling depth was far higher than any previously reported values. Stable cycling was observed because the MIEC solid-state electrolyte material alleviates lithium stress on the dense layer during cycling by providing an integrated lithium ion and electron transport pathway.

### Example 4: Fabrication of a Full Cell Comprising an MIEC Solid-State Electrolyte Material

Synthesis of MIEC (Li₃Pr_{2.5}Nd_{0.5}W₂O₁₂) electrode: Stoichiometric amounts of lithium hydroxide monohydrate, praseodymium nitrate, neodymium oxide, and tungsten (VI) oxide were finely grounded in iso-propanol using zirconia milling media. The sample was dried and then annealed at 800° C. for 6 hours. The powder was then ground again and mixed with carbon black and polyvinylidene fluoride in N-methyl-2-pyrrolidone. The slurry was coated on an aluminum foil, and was then dried and calendared.

Fabrication of Full Cell: Ta-doped LLZO was ALD coated with zinc oxide and, lithium metal was attached to the zinc oxide coated side and heated on a hot plate at 240° C. The Li₃Pr_{2.5}Nd_{0.5}W₂O₁₂ electrode material was punched into a small disc with a diameter of 10 mm and was placed on the other side of the Ta-doped LLZO with a few drops (10 μl) of liquid electrolyte at the interface.

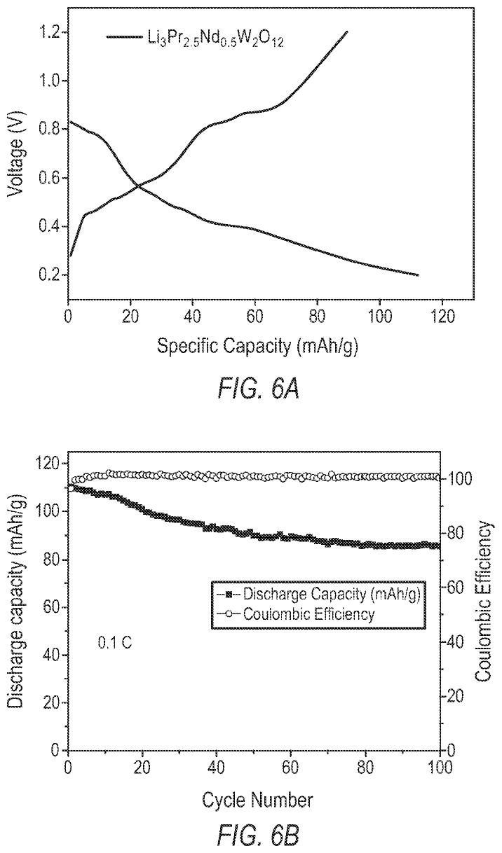

FIG. 6A shows the charge-discharge curves of the MIEC (Li₃Pr_{2.5}Nd_{0.5}W₂O₁₂) electrode material at a current density of 0.1 C. The cell demonstrated an initial capacity of 117 mAh/g. The plateau around 0.8 V corresponds to W(VI)/W(V) reduction, and the plateau around 0.4 V corresponds to W(V)/W(IV) reduction. FIG. 6B shows long term cycling performance of the Li₃Pr_{2.5}Nd_{0.5}W₂O₁₂/Ta-doped LLZO/Li full cell at 0.1 C. The cell demonstrated a capacity of 86 mAh/g, even after 100 cycles, with a coulombic efficiency of 100%. Thus, MIEC solid-state electrolyte materials are suitable for use as an electrode material, in addition to use as a single percolative network to achieve high lithium cycling and high critical current density in “Li-free” anodes and composite cathodes of solid-state lithium batteries.

### EQUIVALENTS AND SCOPE

In the claims articles such as “a,” “an,” and “the” may mean one or more than one unless indicated to the contrary or otherwise evident from the context. Claims or descriptions that include “or” between one or more members of a group are considered satisfied if one, more than one, or all of the group members are present in, employed in, or otherwise relevant to a given product or process unless indicated to the contrary or otherwise evident from the context. The invention includes embodiments in which exactly one member of the group is present in, employed in, or otherwise relevant to a given product or process. The invention includes embodiments in which more than one, or all of the group members are present in, employed in, or otherwise relevant to a given product or process.

Furthermore, the invention encompasses all variations, combinations, and permutations in which one or more limitations, elements, clauses, and descriptive terms from one or more of the listed claims is introduced into another claim. For example, any claim that is dependent on another claim can be modified to include one or more limitations found in any other claim that is dependent on the same base claim. Where elements are presented as lists, e.g., in Markush group format, each subgroup of the elements is also disclosed, and any element(s) can be removed from the group. It should it be understood that, in general, where the invention, or aspects of the invention, is/are referred to as comprising particular elements and/or features, certain embodiments of the invention or aspects of the invention consist, or consist essentially of, such elements and/or features. For purposes of simplicity, those embodiments have not been specifically set forth in haec verba herein. It is also noted that the terms “comprising” and “containing” are intended to be open and permits the inclusion of additional elements or steps. Where ranges are given, endpoints are included. Furthermore, unless otherwise indicated or otherwise evident from the context and understanding of one of ordinary skill in the art, values that are expressed as ranges can assume any specific value or sub-range within the stated ranges in different embodiments of the invention, to the tenth of the unit of the lower limit of the range, unless the context clearly dictates otherwise.

This application refers to various issued patents, published patent applications, journal articles, and other publications, all of which are incorporated herein by reference. If there is a conflict between any of the incorporated references and the instant specification, the specification shall control. In addition, any particular embodiment of the present invention that falls within the prior art may be explicitly excluded from any one or more of the claims. Because such embodiments are deemed to be known to one of ordinary skill in the art, they may be excluded even if the exclusion is not set forth explicitly herein. Any particular embodiment of the invention can be excluded from any claim, for any reason, whether or not related to the existence of prior art.

Those skilled in the art will recognize or be able to ascertain using no more than routine experimentation many equivalents to the specific embodiments described herein. The scope of the present embodiments described herein is not intended to be limited to the above Description, but rather is as set forth in the appended claims. Those of ordinary skill in the art will appreciate that various changes and modifications to this description may be made without departing from the spirit or scope of the present invention, as defined in the following claims.

What is claimed is:

1. A solid-state electrolyte material comprising a composition of Formula (XX): 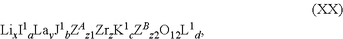
wherein,
I¹ is H, Be, B, Al, Fe, Zn, Ga, or any combination thereof;
J¹ is Na, K, Ca, Rb, Sr, Y, Ag, Ba, Bi, Nd, Pm, Gd, Tb, Ho, Er, Tm, or any combination thereof;
K¹ is Mg, Si, Sc, Ti, V, Ni, As, Se, Tc, Cd, In, Sn, Hf, Ta, Au, Hg, Pb, Ce, Eu, or any combination thereof;
L¹ is F, Cl, Br, I, S, Se, Te, N, P, or any combination thereof;
Z^{A} is Ce, Dy, Eu, Pb, Pr, Sm, Yb, or any combination thereof;
Z^{B} is Co, Cr, Cu, Fe, Ge, Ir, Mn, Mo, Nb, Os, Pd, Pt, Re, Rh, Ru, Sb, Ta, Tb, Ti, V, W, or any combination thereof;
Each of a, b, c, and d is independently 0≤a, b, c, d≤1;
$$0 < x \leq 7 ;$$
$$0 \leq y < 3.5 ;$$
$$0 \leq z < 2.5 ;$$
$$0 < z 1 \leq 3.5 ;$$
$$0 < z 2 \leq 3.5 ,$$
provided that
$$x + a = 7 ;$$
$$y + b + z 1 \leq 3.5 ;$$
$$and$$
$$z + z 2 + c \leq 3.5 .$$

2. The solid-state electrolyte material of claim 1, wherein
(a) I¹ is H, Be, B, Al, Fe, Zn, or Ga;
(b) J¹ is Na, K, Ca, Rb, Sr, Y, Ag, Ba, Bi, Nd, Pm, Gd, Tb, Ho, Er, or Tm;
(c) K¹ is Mg, Si, Sc, Ti, V, Ni, As, Se, Tc, Cd, In, Sn, Hf, Ta, Au, Hg, Pb, Ce, or Eu;
(d) L¹ is F, Cl, Br, I, S, Se, Te, N, or P;
(e) Z^{A} is Ce, Dy, Eu, Pb, Pr, Sm, or Yb;
(f) Z^{B} is Co, Cr, Cu, Fe, Ge, Ir, Mn, Mo, Nb, Os, Pd, Pt, Re, Rh, Ru, Sb, Ta, Tb, Ti, V, or W;
(g) each of a, b, c, and d is independently 0≤a, b, c, d≤1,
$$( h ) \qquad 0 < x \leq 7 ;$$
$$( i ) \qquad 0 \leq y < 3 ;$$
$$\begin{matrix}( j ) & 0 \leq z < 2\end{matrix} ;$$
$$\begin{matrix}( k ) & 0 < z 1 \leq 3\end{matrix} ;$$
$$and$$
$$\begin{matrix}( l ) & 0 < z 2 \leq 3\end{matrix} ,$$
provided that
$$x + a = 7 ;$$
$$y + b + z 1 \leq 3 ;$$
$$and$$
$$z + z 2 + c \leq 2 .$$

3. A solid-state electrolyte material comprising a composition of Formula (I): 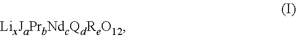
wherein,
J is H, Be, B, Al, Fe, Zn, Ga, or any combination thereof;
Q is Zr, W, or any combination thereof;
R is Sc, Ti, V, Cr, Mn, Fe, Co, Ni, Cu, Zn, Y, Zr, Nb, Mo, Tc, Ru, Rh, Pd, Ag, Cd, Lu, Hf, Ta, Re, Os, Ir, Pt, Au, Hg, Lr, Rf, Db, Sg, Bh, Hs, Mt, Ds, Rg, Cn, Ce, Ge, Sb, Tb, or any combination thereof;
$$0 < x \leq 7 ;$$
$$0 \leq a \leq 1 ;$$
$$0 < b \leq 3.5 ;$$
$$0 \leq c \leq 1 ;$$
$$0 < d \leq 2.5 ;$$
$$and$$
$$0 \leq e \leq 1 .$$

4. The solid-state electrolyte material of claim 3, wherein J is Ga.

5. The solid-state electrolyte material of claim 3 or claim 4, wherein Q is Zr.

6. The solid-state electrolyte material of claim 3 or claim 4, wherein Q is W.

7. The solid-state electrolyte material of any one of claims 3-6, wherein R is Nb, Ce, Cr, or any combination thereof.

8. The solid-state electrolyte material of any one of claims 3-7, wherein R is Nb.

9. The solid-state electrolyte material of any one of claims 3-7, wherein R is Ce.

10. The solid-state electrolyte material of any one of claims 3-7, wherein R is Cr.

11. The solid-state electrolyte material of any one of claims 3-10, wherein 2.5<x≤7.

12. The solid-state electrolyte material of any one of claims 3-11, wherein 5<x≤7.

13. The solid-state electrolyte material of any one of claims 3-12, wherein 6<x≤7.

14. The solid-state electrolyte material of any one of claims 3-13, wherein 1.5<x<4.5.

15. The solid-state electrolyte material of any one of claims 3-14, wherein 0≤a≤0.7.

16. The solid-state electrolyte material of any one of claims 3-14, wherein 0<a<0.7.

17. The solid-state electrolyte material of any one of claims 3-14 or 16, wherein 0<a<0.5.

18. The solid-state electrolyte material of any one of claims 3-14, wherein a is 0.

19. The solid-state electrolyte material of any one of claims 3-18, wherein 1<b<3.5.

20. The solid-state electrolyte material of any one of claims 3-19, wherein 2<b<3.5.

21. The solid-state electrolyte material of any one of claims 3-20, wherein 2.5≤b<3.5.

22. The solid-state electrolyte material of any one of claims 3-21, wherein 0≤c<1.

23. The solid-state electrolyte material of any one of claims 3-22, wherein 0≤c<0.8.

24. The solid-state electrolyte material of any one of claims 3-23, wherein 0.3<c<0.7.

25. The solid-state electrolyte material of any one of claims 3-23, wherein c is 0.

26. The solid-state electrolyte material of any one of claims 3-25, wherein 1<d<2.5.

27. The solid-state electrolyte material of any one of claims 3-26, wherein 1.5<d<2.5.

28. The solid-state electrolyte material of any one of claims 3-27, wherein 1.5<d≤2.0.

29. The solid-state electrolyte material of any one of claims 3-28, wherein 0<e≤0.75.

30. The solid-state electrolyte material of any one of claims 3-28, wherein 0<e≤0.5.

31. The solid-state electrolyte material of any one of claims 3-30, wherein 0<e≤0.3.

32. The solid-state electrolyte material of any one of claims 1-28, wherein e is 0.

33. A solid-state electrolyte material comprising a composition of a formula selected from
Li_{6.2} Ga_{0.2}Pr₃Zr_{1.8}Nb_{0.2}O₁₂;
Li_{6.4} Ga_{0.2}Pr₃Zr_{1.8}Ce_{0.2}O₁₂;
Li_{6.4} Ga_{0.2}Pr_{2.5}Nd_{0.5}Zr₂O₁₂;
Li_{6.6}Ga_{0.2}Pr₃Zr_{1.8}Cr_{0.2}O₁₂; or
Li₃Pr_{2.5}Nd_{0.5}W₂O₁₂.

34. A solid-state electrolyte material comprising a composition of Formula (Ia): 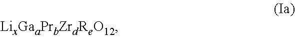
wherein,
R^{D} is W, Sc, Ti, V, Cr, Mn, Fe, Co, Ni, Cu, Zn, Y, Zr, Nb, Mo, Tc, Ru, Rh, Pd, Ag, Cd, Lu, Hf, Ta, W, Re, Os, Ir, Pt, Au, Hg, Lr, Rf, Db, Sg, Bh, Hs, Mt, Ds, Rg, Cn, Ce, Ge, Sb, Tb, or any combination thereof;
$$0 < x \leq 7 ;$$
$$0 \leq a \leq 1 ;$$
$$0 < b \leq 3.5 ;$$
$$0 < d \leq 2.5 ;$$
$$and$$
$$0 \leq e \leq 1 .$$

35. The solid-state electrolyte material of claim 34, wherein
$$6 < x < 7 ;$$
$$0 < a < 1 ;$$
$$2. < b < 3.5 ;$$
$$1 < d < 2 ;$$
$$and$$
$$0 < e < 0.5 .$$

36. The solid-state electrolyte material of claim 35, wherein 6.2≤x≤6.8.

37. The solid-state electrolyte material of claim 35 or claim 36, wherein 0<a<0.3.

38. The solid-state electrolyte material of any one of claims 35-37, wherein 2.25<b<3.25.

39. The solid-state electrolyte material of any one of claims 35-38, wherein 1.5<d<2.25.

40. The solid-state electrolyte material of any one of claims 35-39, wherein 0<e<0.3.

41. A solid-state electrolyte material comprising a composition of Formula (Ib): 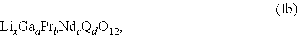
wherein,
Q is Zr, W, or any combination thereof;
$$0 < x \leq 7 ;$$
$$0 \leq a \leq 1 ;$$
$$0 < b \leq 3.5 ;$$
$$0 \leq c \leq 1 ;$$
$$and$$
$$0 < d \leq 2.5 .$$

42. The solid-state electrolyte material of claim 41, wherein
$$2.5 < x < 7 ;$$
$$0 \leq a < 0.5 ;$$
$$2 < b < 3 ;$$
$$0 < c < 1 ;$$
$$and$$
$$0 < d \leq 2 .$$

43. The solid-state electrolyte material of claim 41 or claim 43, wherein
Q is W; and
a is 0.

44. The solid-state electrolyte material of claim 44, wherein 2.5<x<3.5.

45. The solid-state electrolyte material of claim 41 or claim 44, wherein
Q is Zr; and
0<a<0.5.

46. A solid-state electrolyte material comprising a composition of Formula (XX-A): 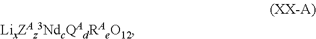
wherein
Z^{A} is Ce, Dy, Eu, Pb, Pr, Sm, Yb, or any combination thereof;
Q^{A} is Zr, W, or any combination thereof;
R^{A} is Sc, Ti, V, Cr, Mn, Fe, Co, Ni, Cu, Zn, Y, Zr, Nb, Mo, Tc, Ru, Rh, Pd, Ag, Cd, Lu, Hf, Ta, Re, Os, Ir, Pt, Au, Hg, Lr, Rf, Db, Sg, Bh, Hs, Mt, Ds, Rg, Cn, Ce, Ge, Sb, Tb, or any combination thereof;
$$0 < x \leq 7 ;$$
$$0 < {z}^{3} \leq 4.5 ;$$
$$0 \leq c \leq 1 ;$$
$$0 < d \leq 2.5 ;$$
$$and$$
$$0 \leq e \leq 1 .$$

47. The solid-state electrolyte material of any one of claims 1-46, wherein the solid-state electrolyte material is ion conducting and electron conducting.

48. The solid-state electrolyte material of any one of claims 1-46, wherein the solid-state electrolyte material has a lithium ion conductivity of at least about 0.05 mS/cm.

49. The solid-state electrolyte material of any one of claims 1-48, wherein the solid-state electrolyte material has a lithium ion conductivity of at least about 0.09 mS/cm.

50. The solid-state electrolyte material of any one of claims 1-49, wherein the solid-state electrolyte material has a lithium ion conductivity of at least about 0.11 mS/cm.

51. The solid-state electrolyte material of any one of claims 1-50, wherein the solid-state electrolyte material has an electron conductivity of at least about 1 μS/cm.

52. The solid-state electrolyte material of any one of claims 1-51, wherein the solid-state electrolyte material has an electron conductivity of at least about 2.50 μS/cm.

53. The solid-state electrolyte material of any one of claims 1-52, wherein the solid-state electrolyte material has an electron conductivity of at least about 10 μS/cm.

54. The solid-state electrolyte material of any one of claims 1-53, wherein the solid-state electrolyte material has an ambipolar conductivity of at least about 1 μS/cm.

55. The solid-state electrolyte material of any one of claims 1-54, wherein the solid-state electrolyte material has an ambipolar conductivity of at least about 2.5 μS/cm.

56. The solid-state electrolyte material of any one of claims 1-55, wherein the solid-state electrolyte material has an ambipolar conductivity of at least about 7.5 μS/cm.

57. The solid-state electrolyte material of any one of claims 1-56, wherein the solid-state electrolyte material has a cubic phase.

58. The solid-state electrolyte material of any one of claims 1-57, wherein the solid-state electrolyte material is substantially free of a secondary phase.

59. A bilayer solid-state electrolyte structure, comprising
a porous laver; and
a dense layer,
wherein at least one of the porous layer and the dense layer comprises the solid-state electrolyte material of any one of claims 1-58.

60. The bilayer solid-state electrolyte structure of claim 59, wherein the porous layer comprises the solid-state electrolyte material of any one of claims 1-58.

61. A trilayer solid-state electrolyte structure, comprising
a first porous layer;
a dense layer; and
a second porous layer
wherein at least one of the first porous layer, the dense laver, and the second porous layer comprises the solid-state electrolyte material of anyone one of claims 1-58.

62. The trilayer solid-state electrolyte structure of claim 59, wherein at least one of the first porous layer and the second porous layer comprises the solid-state electrolyte material of anyone one of claims 1-58.

63. The trilayer solid-state electrolyte structure of claim 59, wherein the first porous layer and the second porous laver each independently comprise the solid-state electrolyte material of anyone one of claims 1-58.

64. The solid-state electrolyte material of any one of claims 1-58, wherein the solid-state electrolyte material is sintered.

65. A solid-state battery comprising a solid-state electrolyte material of any of claims 1-58.

66. The solid-state battery of claim 65, wherein the solid-state electrolyte material is sintered.

67. The solid-state battery of claim 66 wherein the sintered solid-state electrolyte material is incorporated into a host structure for lithium metal plating and stripping.

68. A method for forming a green body, the method comprising:
(a) reacting a precursor mixture to form a solid-state electrolyte material of any one of claims 1-58;
(b) dispersing the solid-state electrolyte material in a solvent to form a dispersed material;
(c) casting the dispersed material on a substrate to form the green body.

69. The method of claim 68, wherein the reacting step (a) comprises calcining the precursor mixture.

70. The method of claim 68, wherein the reacting step (a) further comprises
(a-1) reacting a precursor mixture to form a solid-state electrolyte material; and
(a-2) milling the solid-state electrolyte material to increase uniformity and reduce particle size.

71. A method of forming a sintered solid-state electrolyte, the method comprising forming a green body according to a method of any one of claims 68-70; and sintering the green body to form the sintered solid-state electrolyte.
